(19) United States
(12) Patent Application Publication
(10) Pub. No.: US 2004/0047309 A1
(43) Pub. Date: Mar. 11, 2004

(54) Method and base station for power control in TDMA radio system

(76) Inventor: Kai Barnes, Kempele (FI)

Correspondence Address: PILLSBURY WINTHROP, LLP, P.O. BOX 10500, MCLEAN, VA, 22102, US

(21) Appl. No.: 10/237,181

(22) Filed: Sep. 9, 2002

(51) Int. Cl. H04Q 7/00

(52) U.S. Cl. 370/329

(57) ABSTRACT

The invention relates to a TDMA multicarrier base station and a method for transmit power control in a TDMA multicarrier radio system communicating over multiple time slots assigned to given user terminals. The method according to the invention comprises: allocating a respective transmit power level for at least one of a plurality of user terminals; calculating the sum of transmit powers on each carrier for each time slot separately and allocating the time slots and carriers for the connections to the user terminals in such a way that the sum of transmit power levels in each time slot is minimized.

### FIELD OF THE INVENTION

The present invention relates to time division multiple access (TDMA) radio systems. More precisely it relates to power control in a TDMA multicarrier radio system.

### BACKGROUND OF THE INVENTION

In conventional cellular systems, a base station is allocated a predetermined number of frequency carriers for communicating with mobile stations. Multiuser access methods in GSM systems are based on time division, in which eight users are separated by allocating to each user a unique timeslot in a TDMA frame. The TDMA frame has eight timeslots on one carrier. Depending on traffic requirements, for example based on the assumed number of users within a cell, the base station contains one or several carriers. In a conventional base station with single carrier technique multiple carriers are combined with poor efficiency and bulky implementation. A multicarrier transmitter offers better efficiency and more compact implementation.

A major obstacle in development of the multicarrier transmitters is linearity requirement. Linearity is the difference in the accuracy values through the expected operating range of the transmitter. Peak-to-average ratio measures the distance between a maximum instantaneous power and an average power of a multicarrier signal over a given duration. In most times the instantaneous power is close to the average power, while the maximum power occurs quite seldom. In other words, the maximum instantaneous power is close to the average power with high probability, while the occurrence of high power has a low probability. However, the transmitter linearity requirement is solely determined by peaks occurring seldom.

In order to fulfil the linearity requirement in a power amplifier of the multicarrier base station, adequate headroom is needed in the power amplifier, which, in turn, leads to poor efficiency. Several methods for achieving the necessary linearity performance in power amplifiers are described in WO-0105057. However, in the described methods the base station is forced to reduce the power of defined timeslots by some amount or to zero. This procedure causes impairments to received signal quality. Some peak clipping techniques have also been proposed as a solution for the problem, but they can cause signal deterioration, like growth of error vector magnitude (EVM) and spectral regrowth.

### BRIEF DESCRIPTION OF THE INVENTION

It is thus an object of the invention to provide a method and a base station in such a manner that the above-mentioned problems are solved. This is achieved by a method for transmit power control in a TDMA multicarrier radio system communicating over multiple time slots assigned to given user terminals, comprising: allocating a respective transmit power level for at least one of a plurality of user terminals; calculating the sum of transmit powers on each carrier for each time slot separately and allocating the time slots and carriers for the connections to the user terminals in such a way that the sum of transmit power levels in each time slot is minimized.

The invention also relates to a method for transmit power control in a TDMA multicarrier radio system communicating over multiple time slots assigned to given user terminals, comprising: allocating a respective transmit power level for at least one of a plurality of user terminals; calculating the sum of transmit powers on each carrier for each time slot separately; finding a time slot with the minimum sum of transmit powers when a connection is being initialized; finding a free carrier in the found time slot with the minimum sum of transmit powers and allocating the found time slot and the found carrier for the connection.

The invention also relates to a TDMA multicarrier base station communicating over multiple time slots assigned to given user terminals, the base station comprising: means for allocating a respective transmit power level for at least one of a plurality of user terminals; means for calculating the sum of transmit powers on each carrier for each time slot separately and means for allocating the time slots and carriers for the connections to the user terminals in such a way that the sum of transmit power levels in each time slot is minimized.

The object of the invention is also achieved by a TDMA multicarrier base station communicating over multiple time slots assigned to given user terminals, the base station comprising: means for allocating a respective transmit power level for at least one of a plurality of user terminals; means for calculating the sum of transmit powers on each carrier for each time slot separately; means for finding a time slot with the minimum sum of transmit powers when a connection is being initialized; means for finding a free carrier in the found time slot with the minimum sum of transmit powers and means for allocating the found time slot and the found carrier for the connection.

Preferred embodiments of the invention are described in the dependent claims.

The method of the invention provides several advantages. In a preferred embodiment of the invention the linearity requirement in the base station is achieved without the use of substantial additional hardware. All the problems caused by a large peak-to-average ratio of the multicarrier signal are avoided. There is no need to reduce the power of any timeslots in order to satisfy the linearity requirement of the base station.

### BRIEF DESCRIPTION OF THE FIGURES

In the following, the invention will be described in greater detail with reference to the preferred embodiments and the accompanying drawings, in which

FIG. 1 illustrates an exemplary cellular radio system,

FIG. 2 illustrates an example of a TDMA frame,

FIG. 3 illustrates an exemplary block diagram of a network and a multicarrier base station in accordance with the invention,

FIG. 4 illustrates a method for power control according to exemplary embodiments of the present invention,

FIGS. 5-16 illustrate an example of arranging the time slots according to exemplary embodiments of the present invention.

### DESCRIPTION OF THE EMBODIMENTS

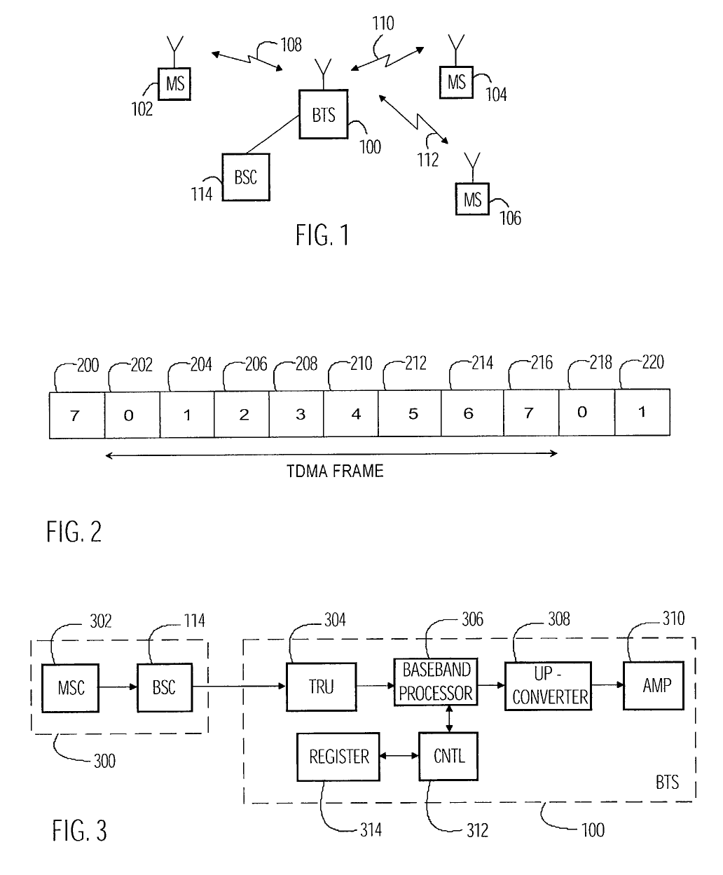

The essential parts of the structure of the cellular radio system may resemble those shown in FIG. 1. The cellular radio system in FIG. 1 is a GSM-based radio system, which employs for example EDGE (Enhanced Data Rates for Global Evolution) technology. The cellular radio system comprises a base station 100 and a plurality of user terminals 102, 104, 106 having a duplex connection 108, 110, 112 to the base station 100. The base station 100 transmits the connections of the user terminals 102, 104, 106 to a base station controller 114, BSC, which forwards the connections to other parts of the system and to a fixed network. The base station controller 114 controls the operation of one or more base stations 100. The other tasks of the base station controller 114 are frequency administration and exchange functions. The base station controller 114 and the base station 100 together form a functional entity sometimes referred to as a base station subsystem, BSS. The base station subsystem, BSS, uses a time divisional multiple access technique (TDMA).

The multicarrier base station 100 includes one or more transmitters capable of producing a multicarrier signal, which comprises up to 16 carrier waves. In the GSM systems, one carrier wave usually comprises eight time slots, i.e. eight physical channels. One base station 100 may serve one cell or several sectorized cells. The cell diameter may vary from a few metres to dozens of kilometres. The transmit power of the base station 100 determines the absolute cell size.

When a user terminal 102, 104, 106 informs the system that it wants a channel, e.g., it wants to establish a connection, the base station controller 114 via the base station 100 assigns a traffic channel on which the exchange of user data is performed. Different types of messages and user data move on different types of channels.

The user terminals 102, 104, 106 perform continuous measurements on the quality and the power level of the serving cell, and of the power levels of the adjacent cells. The base station 100 itself also performs measurements on the quality and power level of the link to the user terminals 102, 104, 106. The range of variation of the transmit power level is for instance 30 dB.

FIG. 2 illustrates an example of a TDMA frame. In a GSM system a time divisional multiple access (TDMA) is utilized, with which each frequency carrier is subdivided into eight different time slots numbered from 0 to 7. In a TDMA technique the users share a physical radio channel, where they are assigned time slots. All the users sharing the physical resource have their own assigned, repeating time slot within a group of time slots called a frame. FIG. 2 shows time slots, of which time slots 202, 204, 206, 208, 210, 212, 214, 216 form a frame of 8 time slots. A time slot 200 is a part of the previous frame and time slots 218, 220 are parts of the next frame. Each time slot of the frame is assigned to an individual user. In order to increase the data transmission rate, it is also possible to assign several time slots to an individual user. All the users of the same frequency share a common frame. Each user uses only the time slot that has been assigned to that user and remains silent during other time slots. Thus, for example, one user always uses the second time slot of each frame. The transmission thereby comprises bursts. The duration of a time slot is 577 ms and the duration of a frame 4,615 ms.

FIG. 3 illustrates an exemplary block diagram of a network and a multicarrier base station in accordance with the invention. The areas marked with dashed lines in FIG. 3 illustrate parts of a network 300 and the base station 100. The network part 300 comprises a mobile switching center 302, MSC, which performs the switching functions and controls interworking with other networks. The mobile switching center 302 is capable of routing calls from the fixed network—via the base station controller 114 and the base station 100—to an individual user terminal. Depending on the network size, there may be several mobile switching centers 302 or only one.

The base station part 100 comprises a transmission unit, TRU 304, a baseband processor 306, an up-converter 308, an amplifier 310, a controller 312 and a register 314. In accordance with the GSM protocol, the digital data is formatted into bursts of 148 bits. The bits are rearranged so as to spread temporally adjacent bits over a larger time frame and then reassembled at the receiving station so as to reduce the effect of lost data. The digital data is processed in the baseband processor 306. The baseband processor 306 sets the transmitted signal level, i.e. the power level, suitable for each carrier and time slot used. After baseband processing, the digital data is modulated onto a radio frequency (RF) carrier and forwarded for wireless transmission to the user terminals.

The controller 312 and the register 314 are alternatively a part of the baseband processor 306 although in FIG. 3 they are drawn apart. The controller 312 controls the functions of the base station 100 and is usually implemented as a processor and its software, but various hardware solutions are also feasible, e.g. a circuit built of logic components or one or more application specific integrated circuits ASIC. A combination of these different implementations is also possible. The controller 312 controls the allocation of each user transmit power levels in different time slots and carriers. The register 314 is updated with the transmit power data of the base station 100.

According to one embodiment of the invention, sums of transmit powers on each carrier for each time slot separately are calculated in the controller 312. After the calculation of the sums of the transmit powers in the controller 312, the time slots and carriers for the connections are allocated to the user terminals in such a way that the sum of transmit power levels in each time slot is minimized.

According to another embodiment of the invention, sums of transmit powers on each carrier for each time slot are calculated separately in the controller 312. After the calculation of the sums of the transmit powers in the controller 312, the sums of the transmit powers of each time slot are updated to the register 314. Thus the register 314 contains, besides the sums of the transmit powers, also the transmit power data of each carrier and time slot. Alternatively the sums of the transmit powers of each time slot are not updated after each time slot. Instead the sums of the transmit powers of the time slots are updated for example after a predetermined period of time. When a connection is initialized, i.e. a new connection is initialized or an ongoing connection is reallocated, a time slot with the minimum sum of transmit powers is found in the register 314 by the controller 312. After that a free carrier is found in the found time slot with the minimum sum of transmit powers in the register 314. Then the found time slot and the found carrier are allocated for the connection by the controller 312.

It is possible that changes of said calculated sum of the transmit powers of each time slot are calculated by the controller 312 and for example updated in the register 314. Thus for example an ongoing connection may be reallocated to the found time slot and the found carrier when the calculated sum of transmit powers of the found time slot has been the minimum sum of transmit powers for a predetermined period of time.

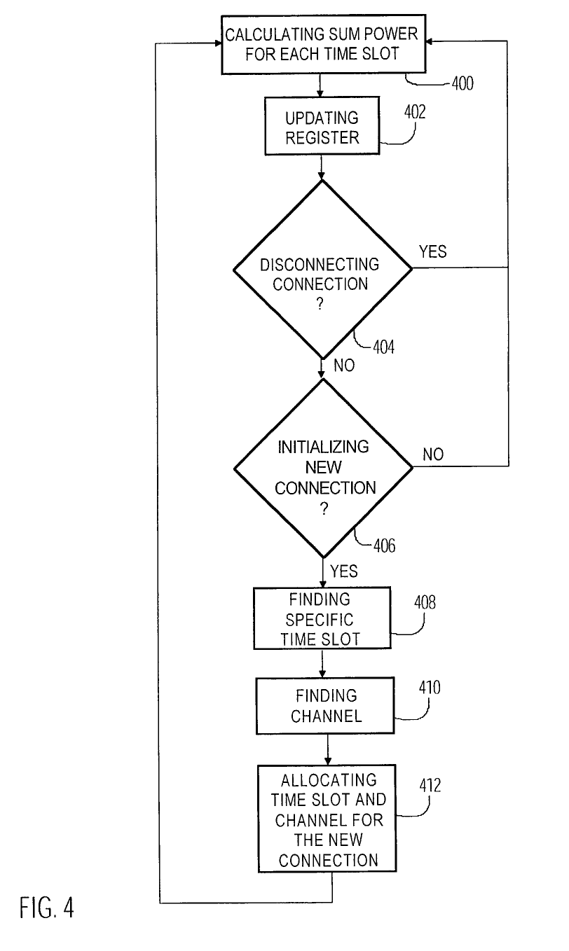

With reference to a flow diagram in FIG. 4, let us next examine a method according to one embodiment of the invention. In step 400 the sum of transmit powers on each carrier for each time slot are calculated separately. The calculation takes place in the controller of the base station. Next in step 402 a register of the calculated sums of the transmit powers is updated. If a connection is disconnected in step 404, the process returns to step 400 in which the sums of transmit powers on each carrier for each time slot are calculated again. If in step 406 a new connection is initialized, the process moves to step 408, wherein a specific time slot with the minimum sum of transmit powers is found in the register. Next in step 410, a free carrier in the found time slot with the minimum sum of transmit power is found. In step 412 the found time slot and carrier are allocated for the new connection. After step 412, the process then returns to steps 400 and 402, wherein the sum of transmit powers on each carrier for each time slot are calculated again and updated to the register.

The sum of transmit powers calculated in step 400 can alternatively be a statistical sum of transmit powers for a predetermined period of time. In that case, the register of the calculated sums of the transmit powers is not necessarily updated after each time slot either, but only after a predetermined period of time. It is possible that the calculation of the sums of the transmit powers in step 400 and the updating of the register in step 402 are not performed every time a connection has been disconnected or a new connection is being initialized. Instead, steps 400 and 402 may be performed after a given number of disconnections or new connections have appeared. Steps 400 and 402 may also take place if, for some reason, the power level of a given time slot is changed during an ongoing connection. Alternatively the steps 400 and 402 are not performed every time the power level of a time slot is changed. It is feasible that after the power level of one or more time slots has changed a given order of magnitude, steps 400 and 402 are performed.

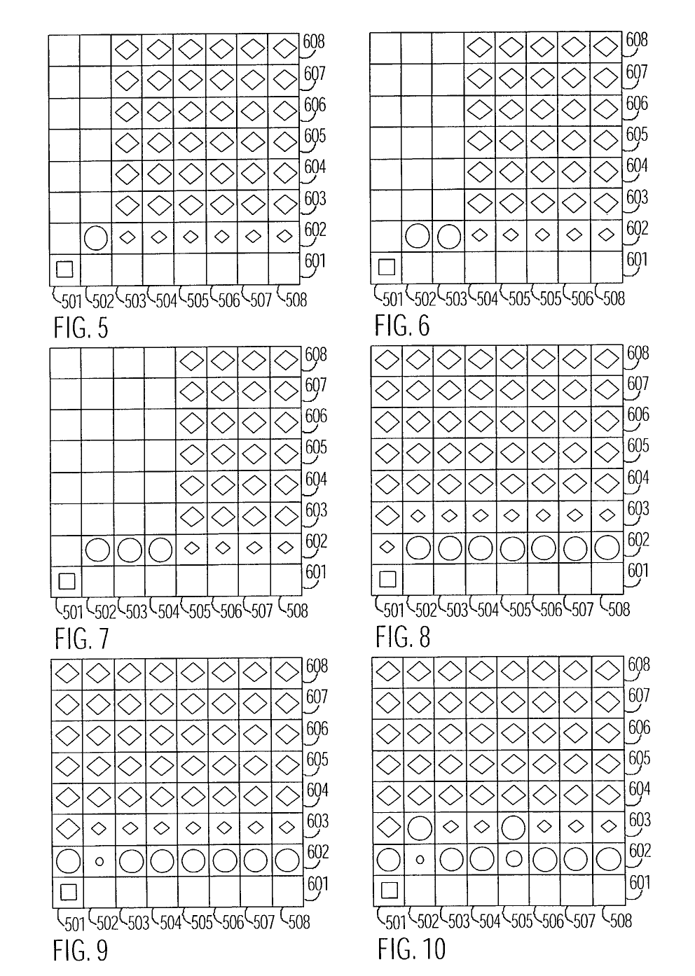

FIGS. 5-16 illustrate an example according to one embodiment of the invention. In FIGS. 5-16 it is shown step by step how the transmit power levels allocated for certain timeslots are arranged when the traffic is increasing. Let us take the idle time of the cell of a cellular network as a starting point to describe this embodiment of the invention. The idle time is the time during which there are no ongoing connections and the system is ready to receive incoming connections. The idle time occurs most probably at night when the traffic in the network is at minimum.

In FIGS. 5-16 the rows 601-608 illustrate the different carriers of the TDMA multicarrier radio system. Columns 501-508 illustrate the eight time slots in the TDMA frame. The base station transmits the information in bursts in different time slots 501-508. In FIGS. 5-16 there are different symbols in each time slot and carrier for indicating respective transmit power levels to user terminals, which are assigned to particular time slots. The square symbol in all of the FIGS. 5-16 illustrate a control burst, which is sent repeatedly at a maximum power. In FIGS. 5-16 the control information is in the first time slot 501 on the physical control channel, i.e. on the carrier 601. This timeslot and carrier is from now on referred to as 501/601. The physical control channel can also be a carrier 602-608 any other than the carrier 601.

In FIGS. 5-16 the spherical symbols of different sizes indicate the different transmit power levels that are required at certain time slots 501-508 and carriers 601-608 for reliable communications. The largest spherical symbols indicate a high transmit power, the medium sized spherical symbols indicate a medium transmit power and the smallest spherical symbols indicate a low transmit power. In reality there are for instance 16 different transmit power levels, in a control range of 30 dB, in which case the ratio between the highest and the lowest transmit power is 1000. The three transmit power levels described in FIGS. 5-16 are chosen only as a set of examples. In practice the transmit power control is accomplished for example by only one step, for instance 2 dB, at a time. If the base station discovers that a user terminal does not receive its signal at a sufficient power level for reliable communications, it may apply power control on its own RF output and transmit at different power levels in each time slot 501-508. If the power level has been for example too low, it is increased. Each power control command controls only one time slot, i.e. the user terminal whose received power level has been too low. The power level on each timeslot 501-508 depends for example on the path loss between the base station antenna and the user terminal. Path loss has a non-linear relation to the physical distance between the parties, and in general, it can be related to the 2^{nd}, 3^{rd} and 4^{th} power of the distance. Use of the 4^{th} power would be realistic in a multipath environment. User terminals typically have a uniform distribution over the cell region. In FIGS. 5-16 the user terminals will be referred to as users.

The diamond-shaped symbols in FIGS. 5-16 illustrate those free time slots to which the next new user connection can be allocated. The smallest diamond-shaped symbols illustrate the primary allocation time slots and the largest illustrate the secondary allocation time slots. However it is also possible to allocate the users in any of the free time slots regardless of the primary or secondary symbols. It is also possible to change the time slot of an ongoing connection to a different time slot.

At the beginning only the control burst occupies the time slot 501 of the carrier 601 (501/601). When a new connection is initialized, for example a call is made from the cell or to the cell, the carrier 602 and a time slot any other than the time slot 501 are allocated for the new connection. In FIG. 5 this new connection occupies the timeslot 502 of the carrier 602 (502/602). It is supposed that the carrier 601 is dedicated primarily to a control channel and therefore all the other time slots 502-508 on the carrier 601 are only utilised if needed. One of the reasons for that is that the control channel uses maximum power in all the time slots, although only the first time slot 501 is used for transmitting the control information. This way interference to other cells can be reduced. The base station starts to transmit for instance at the maximum power to the user. However the base station soon decreases the power based on the measured power reported by the user.

Next a new connection is initialized or the previous connection is disconnected. If a new connection is initialized while the first connection is ongoing, the allocated carrier is for example the carrier 602 or 603 and the time slot is any other than 501 or 502. FIG. 6 illustrates how the second user is allocated in the time slot 503 on the carrier 602 (503/602). The procedure of allocating new users on different carriers and time slots may go on until different time slots are allocated on every carrier.

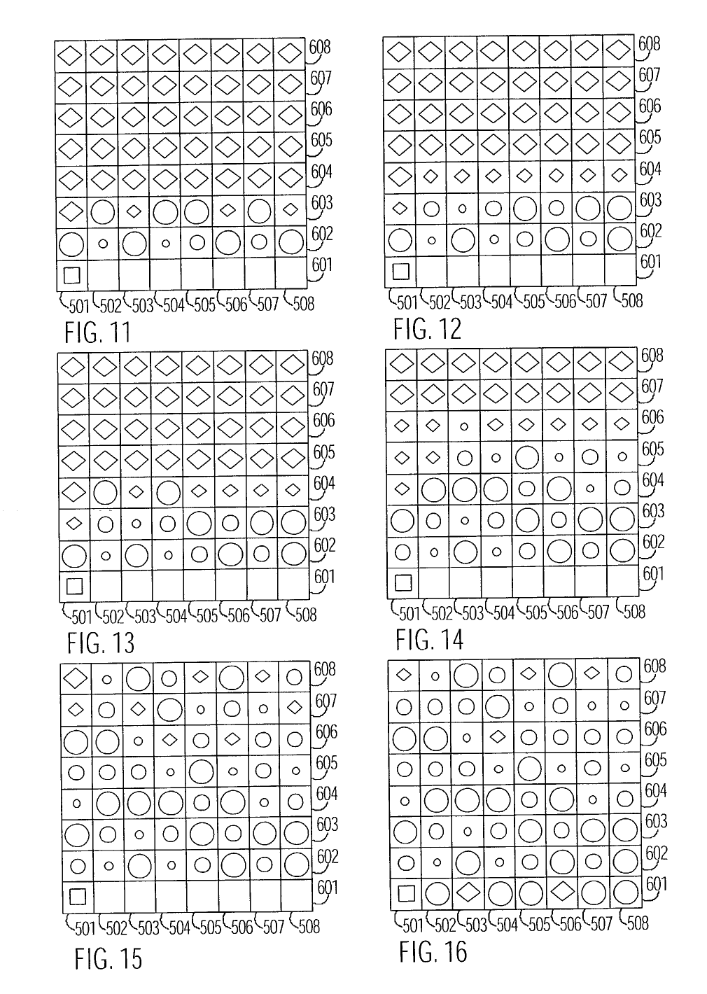

In FIG. 7 a third user is allocated on 504/602 and in FIG. 8 fourth to seventh users are allocated on 505-508/602. FIG. 9 illustrates a situation where one more user is allocated on 501/602, and the carrier 602 is now fully loaded. In the situation illustrated in FIG. 9 the power level for 502/602 is decreased. It is possible that the decreasing of the power level for 502/602 has happened gradually, for example at the same time as the user has moved closer to the base station. FIG. 10 illustrates a situation in which two new users are allocated in the time slots 502 and 505 on the carrier 603. These time slots 502, 505 are selected because of smaller powers on the carrier 602 in these particular time slots 502, 505. Thus, when the new connections are initialized, the time slots 502, 505 are selected based on the register of the calculated sums of the transmit powers. Because the time slots 502, 505 had smaller sum powers than the other time slots 501, 503, 504, 506, 507, 508, the time slot selections in the situation of FIG. 10 were directed to said time slots 502, 505. In FIG. 11 two new users are allocated on the carrier 603 in the time slots 504, 507. Also the used transmit power level of some users on the carrier 602 is changed.

FIG. 12 illustrates a situation where there are seven users allocated on the carrier 603. The time slot 501 has now one user and the control information, and the other time slots 502-508 have two users. In FIG. 13 there are two users allocated on the carrier 604. Once again the time slot selection is based on the minimum sum of transmit powers in the time slots 502, 504 concerned.

FIG. 14 illustrates a situation after several users have been connected to the cell and have left it. FIG. 15 shows a later situation, where the cell is almost fully loaded. There have been several connections to and disconnections from the cell before reaching the situation in FIG. 15. FIG. 16 illustrates a situation in which the cell is almost fully loaded. There are only a few free time slots. A situation like this is possible for example during a rush hour. In FIG. 16 the users are allocated in time slots and carriers in such a way that the sum of transmit power levels in each time slot is minimized.

Even though the invention is described above with reference to an example according to the accompanying drawings, it is clear that the invention is not restricted thereto but it can be modified in several ways within the scope of the appended claims.

What is claimed is:

1. A method for transmit power control in a TDMA multicarrier radio system communicating over multiple time slots assigned to given user terminals, comprising:
allocating a respective transmit power level for at least one of a plurality of user terminals;
calculating the sum of transmit powers on each carrier for each time slot separately;
allocating the time slots and carriers for connections to the user terminals in such a way that the sum of transmit power levels in each time slot is minimized.

2. A method for transmit power control in a TDMA multicarrier radio system communicating over multiple time slots assigned to given user terminals, comprising:
allocating a respective transmit power level for at least one of a plurality of user terminals;
calculating the sum of transmit powers on each carrier for each time slot separately;
finding a time slot with the minimum sum of transmit powers when a connection is being initialized;
finding a free carrier in the found time slot with the minimum sum of transmit powers;
allocating the found time slot and the found carrier for the connection.

3. The method of claims 1 and 2, further comprising:
updating a register with the calculated sums of the transmit powers;
finding a time slot with the minimum sum of transmit powers in the register;
finding a free carrier in the found time slot with the minimum sum of transmit powers in the register;
allocating the found time slot and the carrier for the connection.

4. The method of claims 1 and 2, further comprising:
calculating changes of said calculated sum of the transmit powers of each time slot;
allocating the found time slot and the found carrier for an ongoing connection when the calculated sum of transmit powers of the found time slot has been the minimum sum of transmit powers for a predetermined period of time.

5. The method of claims 1 and 2, wherein the calculated sum of transmit powers on each carrier for each time slot is the statistical sum of transmit powers for a predetermined period of time.

6. The method of claims 1 and 2, further comprising: recalculating the sum of transmit powers on each carrier for each time slot and updating a register with the calculated sums of the transmit powers once one or more connections has been disconnected.

7. The method of claims 1 and 2, further comprising: recalculating the sum of transmit powers on each carrier for each time slot and updating a register with the calculated sums of the transmit powers once the transmit power level of one or more connections has been changed.

8. The method of claims 1 and 2, wherein the TDMA multicarrier radio system employs EDGE (Enhanced Data Rates for Global Evolution) technology.

9. A TDMA multicarrier base station communicating over multiple time slots assigned to given user terminals, the base station comprising:
means for allocating a respective transmit power level for at least one of a plurality of user terminals;
means for calculating the sum of transmit powers on each carrier for each time slot separately;
means for allocating the time slots and carriers for the connections to the user terminals in such a way that the sum of transmit power levels in each time slot is minimized.

10. A TDMA multicarrier base station communicating over multiple time slots assigned to given user terminals, the base station comprising:
means for allocating a respective transmit power level for at least one of a plurality of user terminals;
means for calculating the sum of transmit powers on each carrier for each time slot separately;
means for finding a time slot with the minimum sum of transmit powers when a connection is being initialized;
means for finding a free carrier in the found time slot with the minimum sum of transmit powers;
means for allocating the found time slot and the found carrier for the connection.

11. The TDMA multicarrier base station of claims 9 and 10, further comprising:
a register;
means for updating the register with the calculated sums of the transmit powers;
means for finding a time slot with the minimum sum of transmit powers in the register;
means for finding a free carrier in the found time slot with the minimum sum of transmit powers in the register;
means for allocating the found time slot and the carrier for the connection.

12. The TDMA multicarrier base station of claims 9 and 10, further comprising:
means for calculating changes of said calculated sum of the transmit powers of each time slot;
means for allocating the found time slot and the found carrier for an ongoing connection when the calculated sum of transmit powers of the found time slot has been the minimum sum of transmit powers for a predetermined period of time.

13. The TDMA multicarrier base station of claims 9 and 10, wherein the calculated sum of transmit powers on each carrier for each time slot is the statistical sum of transmit powers for a predetermined period of time.

14. The TDMA multicarrier base station of claims 9 and 10, comprising:
a register;
means for recalculating the sum of transmit powers on each carrier for each time slot and means for updating a register with the calculated sums of the transmit powers once one or more connections has been disconnected.

15. The TDMA multicarrier base station of claims 9 and 10, comprising:
a register;
means for recalculating the sum of transmit powers on each channel for each time slot and means for updating the register with the calculated sums of the transmit powers once the transmit power level of one or more connections has been changed.

16. The TDMA multicarrier base station of claims 9 and 10, wherein the TDMA multicarrier base station employs EDGE (Enhanced Data Rates for Global Evolution) technology.
